(19) United States
(12) Patent Application Publication
(10) Pub. No.: US 2025/0364692 A1
(43) Pub. Date: Nov. 27, 2025

(54) SPRING, CCU CARRIER AND A BATTERY SYSTEM

(71) Applicant: SAMSUNG SDI CO., LTD., Yongin-si (KR)

(72) Inventor: Michael URBANITSCH, Raaba-Grambsch (AT)

(21) Appl. No.: 18/957,485

(22) Filed: Nov. 22, 2024

(30) Foreign Application Priority Data
May 27, 2024 (EP) 24178158.2

(51) Int. Cl. H01M 50/503; H01M 50/249; H01M 50/262; H01M 50/507; H01M 50/514; H01M 50/522

(52) U.S. Cl. CPC H01M 50/503; H01M 50/249; H01M 50/262; H01M 50/507; H01M 50/514; H01M 50/522

(57) ABSTRACT

A spring for a battery system includes: a main body having a first spring action side, a second spring action side opposite to the first spring action side in a spring action direction, a first side, and a second side opposite to the first side. The main body has a V-shaped opening including a plurality of leg openings extending through the main body in a thickness direction of the main body and a pair of slot openings extending through the main body in the thickness direction. The V-shaped opening is oriented such that the plurality of leg openings are symmetric with respect to a central axis of the main body, which is parallel to the spring action direction, and the pair of slot openings respectively extend from the first side and the second side of the main body toward the central axis.

### CROSS-REFERENCE TO RELATED APPLICATION

The present application claims priority to and the benefit of European Patent Application No. 24178158.2, filed on May 27, 2024, in the European Patent Office, the entire disclosure of which is incorporated herein by reference.

### BACKGROUND

### 1. Field

Aspects of embodiments of the present disclosure relate to a spring for a battery system, a CCU carrier including the spring, and a battery system including the CCU carrier.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable batteries. An electric vehicle may be solely powered by batteries (a so-called Battery Electric Vehicle “BEV”) or may include a combination of an electric motor and, for example, a conventional combustion engine (a so-called Plugin Hybrid Electric Vehicle “PHEV”). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located in (e.g., is accommodated in) a casing, and electrode terminals, which are positioned on the outside of the casing, establish an electrically conductive connection to the electrodes. The casing may have, for example, a cylindrical or rectangular shape.

A battery module is formed of a plurality of battery cells connected together in series or in parallel. For example, the battery module is formed by interconnecting the electrode terminals of the plurality of battery cells, in a number and configuration depending on a desired amount of power, to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, or respectively the battery cells, may be configured in a series, parallel, or a mixture of both to provide the desired voltage, capacity, and/or power density. Components of a battery pack include the individual battery modules and interconnects, which provide electrical conductivity between the battery modules.

Mechanical integration of a battery pack is achieved by appropriate mechanical connections between the individual components, for example, between the battery modules and between them and a supporting structure of the vehicle. These connections should remain functional and save during the average service life of the battery system. Further, installation space and interchangeability specifications should be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors, such as bolts or screws. In some cases, the battery modules are confined by fastening side plates to lateral sides of the carrier framework. Further, cover plates may be fixed atop and below the battery modules.

The carrier framework of the battery pack is mounted to a carrying structure of the vehicle. When the battery pack is to be fixed at the bottom of the vehicle, the mechanical connection may be established from the bottom side by, for example, bolts passing through the carrier framework of the battery pack. The framework is generally made of aluminum or an aluminum alloy to reduce the overall weight of the construction.

A conventional battery system, despite any modular structure, usually includes a battery housing that acts as an enclosure to seal the battery system against the environment and provides structural protection of the battery system's components. The housed battery system is usually mounted, as a whole, into its application environment, for example, an electric vehicle. Thus, replacement of defective system parts, for example, a defective battery submodule, requires dismounting the entire battery system and removal of its housing first. Even defects of small and/or cheap system parts may require dismounting and replacement of the entire battery system and its separate repair. Because high-capacity battery systems are expensive, large, and heavy, the procedure is burdensome, and storage, for example, in the mechanic's workshop, of the bulky battery system is difficult.

In battery systems, and in the manufacturing processes thereof, springs may be used to support connection mechanisms. Mechanical springs known in the art include leaf-, plate-, spiral-, and S-shaped springs. However, these types of springs usually yield in several directions without additional guidance.

### SUMMARY

Embodiments of the present disclosure provide springs for use in battery systems, for example, in cell contact units (CCU) carriers, that overcome the above-described shortcomings.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a spring for a battery system is provided. The spring includes a main body having a first spring action side, a second spring action side opposite to the first spring action side portion in a spring action direction, a first side, and second side. The main body has a V-shaped opening including a plurality of leg openings extending through the main body in a thickness direction of the main body. The V-shaped opening is oriented such that the plurality of leg openings are symmetric with respect to a central axis of the main body, which is parallel to the spring action direction. The main body has a pair of slot openings extending through the main body in the thickness direction, and the pair of slot openings respectively extend from the first and second sides of the main body toward the central axis.

According to another embodiment of the present disclosure, a cell contact unit (CCU) carrier for a battery system is provided. The CCU carrier includes a carrier member having a spring as described above. The carrier member includes a clip member that is in mechanical communication with the spring so that the clip member yields through spring action of the spring during clipping.

According to another embodiment of the present disclosure, a battery system includes a battery cell stack including a plurality of battery cells and a frame member coupled to the battery cell stack and having a plurality of frame openings. The battery system includes a plurality of CCU carriers clipped into respective frame openings of the frame member by a first clip member that is in mechanical communication with a spring, as described above, such that the first clip member yields through the spring action of the spring during clipping the carrier member into a respective opening.

According to another embodiment of the present disclosure, a method of manufacturing a battery system includes coupling a plurality of busbars to a cell contact unit (CCU) carrier, clipping a plurality of the CCU carriers with the coupled busbars into respective frame openings in a frame member so that the first clip member yields through the spring action of the spring during the clipping of the CCU carrier into a respective frame opening until retained in the frame opening of the frame member, and coupling the frame member including the clipped plurality of CCU carriers to a respective side of a battery cell stack.

According to another embodiment of the present disclosure, a vehicle including a battery system as described above is provided.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a perspective view of a spring according to an embodiment;

FIG. 2 illustrates a compression response of the spring shown in FIG. 1;

FIG. 3 illustrates force distribution in the spring shown in FIG. 1 in response to compression;

FIG. 4 is a CCU carrier for a battery system according to an embodiment;

FIG. 5 is a cross-sectional view of the CCU carrier for a battery system shown in FIG. 4;

FIG. 6 is a perspective view of a CCU carrier for a battery system with a busbar according to an embodiment of the present disclosure; and

FIGS. 7A to 7D illustrate a method for manufacturing a battery system according to an embodiment of the present disclosure.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. In the drawings, like reference numerals denote like elements, and redundant descriptions may be omitted or only briefly repeated. The present disclosure, however, may be embodied in various different forms, and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described. In the drawings, the relative sizes of elements, layers, and regions may be exaggerated for clarity.

As used herein, the term “and/or” includes any and all combinations of one or more of the associated listed items. Further, the use of “may” when describing embodiments of the present disclosure refers to “one or more embodiments of the present disclosure.” In the following description of embodiments of the present disclosure, the terms of a singular form may include plural forms unless the context clearly indicates otherwise. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that although the terms “first” and “second” are used to describe various elements, these elements should not be limited by these terms. These terms are only used to distinguish one element from another element. For example, a first element may be named a second element and, similarly, a second element may be named a first element, without departing from the scope of the present disclosure.

As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being “above” or “on” another film, region, or element, it can be directly on the other film, region, or element, or intervening films, regions, or elements may also be present.

Herein, the terms “upper” and “lower” are defined according to the z-axis. For example, the upper cover is positioned at the upper part of the z-axis, whereas the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the following description of embodiments of the present disclosure, the terms of a singular form may include plural forms unless the context clearly indicates otherwise.

According to one embodiment of the present disclosure, a spring for a battery system and/or for a cell contact unit (CCU) carrier is provided. The spring includes a main body having a thickness (e.g., a predefined or predetermined thickness) and having a first spring action side portion and a second spring action side portion opposite to the first spring action side portion defining (or in) a spring action direction. The main body has at least one V-shaped opening. The V-shaped opening includes a plurality of leg openings penetrating (or extending through) the main body in a thickness direction of the main body. The V-shaped opening is oriented such that the plurality of leg openings are symmetric with respect to a central axis of the main body, which is parallel to the spring action direction. The main body also has a pair of slot openings penetrating (or extending through) the main body in the thickness direction, and the pair of slot openings respectively extend from opposite transversal side portions (or opposite sides) of the main body toward the central axis.

The main body may have a square or rectangular surface area having a uniform thickness. The main body may have cuboid shape. The main body may be a flat main body in which its thickness is a shortest dimension from among a height direction (spring action direction) and a width direction (transversal direction). The pair of slot openings respectively extend from opposite transversal side portions of the main body toward the central axis while being spaced from each other to ensure connectivity of the spring. The first/second spring action side portions, or compression side portions, may be side portions (or sides) that are configured to be compressed in response to a compression force and to provide a restoring force in the spring. Thus, the spring may expand again in the spring action direction upon release (or removal) of the compression force. The transversal side portions may be side portions on adjacent side portions of the spring action side portions. The leg openings may define the straight parts of a V-shape that meet at a vertex or tip portion to define the V-shape.

The spring has excellent flexibility in the spring action direction allowing for a well-defined spring path length (e.g., compression depth) while maintaining stiffness in the transversal direction perpendicular to the spring action direction. The stiffness is achieved due to the V-shaped openings and the slot openings, which provides flexibility in response to a compression force acting on the spring action side. Additionally, the spring has improved damping properties with homogeneous force distribution in the direction of the line of action of the force. Further, the spring has an advantage that only little space is required, for example, it may have a thickness of less than about 1 mm. For example, the spring can maintain a very flat shape and, therefore, can be integrated in a battery system in space saving manner. The space efficiency as well as the combination with flexibility while having stiffness in transversal direction makes the spring suitable for being integrated in a CCU carrier. Further, the spring can be easily manufactured by using an injection moulding process. In the compressed state, the slot openings and/or the V-shaped opening may close or shrink in response to compression, which may define a maximum compression depth.

In addition to the space savings compared to coil or leaf springs, characteristics of the spring may be individually adjusted or set, such as the spring constant, the spring travel path, and the stiffness in the non-spring (orthogonal) direction. This is achieved by specifically configuring the shape features (e.g., length of leg openings, angle of leg openings) and/or the material thickness. This allows manufacturers and users to vary the spring for different applications by controlling the characteristics of the above spring and the described spring structures.

According to an embodiment, the pair of the slot openings respectively extend in a direction parallel to the plurality of leg openings of the V-shaped opening. Thus, due to the symmetric arrangement, the force distribution over the spring (e.g., the main body) can be improved. For example, hot spots of increased forces (e.g., force concentration) in the material of the spring may remain localized in response to a compression force acting on the spring.

According to embodiment, the pair of the slot openings respectively extend to overlap with the respective leg openings in the spring action direction. This may facilitate flexibility because the slot openings extend to overlap the leg openings of the V-shaped opening. Thus, the transversal side portions can bend slightly inwardly to provide compression path length.

According to an embodiment, a length of at least one slot opening and/or at least one leg opening is a at least a quarter of an overall width between the opposite side portions of the main body. Flexibility may be enhanced by expanding the length of the slot openings and/or leg openings and/or adjusted as desired.

According to an embodiment, the main body has recessed portions on the transversal side portions and extending in spring action direction. The pair of slot openings respectively extend toward the central axis from a slot start portion located within the corresponding recessed portion. The recessed portions facilitate the transversal side portions bending slightly inwardly to provide support for the compression of the spring.

According to an embodiment, an end portion on the transversal side portions of each recessed portion has a curved portion (or curved surface). The facilitates the response of the spring to provide a spring action and to bend slightly inwardly to generate the spring path.

According to an embodiment, another end portion of the recessed portion is formed at where the slot start portion is located. Thus, the angle before self-contact across the slot opening is larger, which may increase the spring path length.

According to an embodiment, the main body has a plurality of V-shaped openings and a plurality of pairs of slot openings, which are alternatingly arranged in the spring action direction. Thus, the spring path length can be increased while maintaining transversal stiffness in the same proportion.

According to an embodiment, the main body has a triangular opening located on the central axis and oriented symmetric with respect to the central axis. This triangular opening may increase stability and force distribution in the spring material.

According to an embodiment, the main body includes (or is made of) a metal. For example, the metal may be steel. In other embodiments, the spring may be aluminum or steel alloy. This may improve rigidity of the spring.

According to an embodiment, the main body includes (or may is made of) plastic. This may simplify the production of the spring.

According to an embodiment, the main body is a plastic body that is formed by injection molding. Therefore, in comparison with conventional springs, the spring according to embodiments of the present disclosure offers a low-cost variant that can be manufactured in a simple manner by injection moulding. The V-shaped spring can be manufactured from a plastic injection molded part with only one demolding direction locally.

According to an embodiment, a CCU carrier for a battery system is provided. The CCU carrier includes a carrier member including a spring as described above. In addition, the carrier member further includes a first clip member, which is in mechanical communication with the spring so that the first clip member yields (e.g., tilts or moves) in the spring action direction during clipping (e.g., during a clipping process). In other words, the spring may facilitate or support the first clip member in yielding during a clipping. Thus, the CCU carrier can be clipped into a frame (e.g., a metal frame) in an easier manner while saving space and, in addition, while proving transversal stiffness in conjunction with a desired spring effect.

According to an embodiment, the carrier member further includes a second clip member that extends in a transversal direction with respect to the spring action direction for retaining a busbar that is coupled to the carrier member. Thus, because the spring is stiff in the transversal direction even when compressed, the busbar may be fixedly held in place even during clipping.

According to an embodiment, a battery system is provided that includes a spring as described above. All the above aspects and features translate as well to a battery system including such spring.

According to an embodiment, the battery system includes a battery cell stack including a plurality of battery cells. At least one frame support member is coupled to at least one side (e.g., side portion) of the battery cell stack and includes a plurality of frame openings. The battery system may further include a plurality of CCU carriers clipped into respective frame openings of the frame support member. The first clip member is in mechanical communication with a spring, as described above, so that the first clip member yields (e.g., moves or tilts) in the spring action direction in response to compression of the spring during clipping.

According to an embodiment, the carrier member further includes a second clip member that extends in a transversal direction with respect to the spring action direction and is configured to retain a busbar that is coupled to the carrier member.

According to an embodiment, a method of manufacturing a battery system includes providing a plurality of CCU carriers. The method includes coupling a plurality of busbars to the CCU carrier. The method includes providing at least one frame support member including a plurality of frame openings. The method further includes clipping the plurality of CCU carriers with the coupled busbars into respective frame openings so that the first clip member yields through the spring action of the spring during the clipping of the CCU carrier into a respective frame opening until being retained in (e.g., arrested in) the frame opening of the frame support member. The method further includes providing a battery cell stack including a plurality of battery cells. The method further includes coupling the frame support member including the clipped plurality of CCU carriers to a respective side of the battery cell stack. Thus, an improved assembly process is provided, in which the CCU carrier can be clipped into a frame (e.g., metal frame) in an easier manner while saving space and, in addition, while proving transversal stiffness in conjunction with a desired spring effect to fixate the busbars in the coupling process.

According to an embodiment, the carrier member further includes a second clip member that extends in a transversal direction with respect to the spring action direction, and the coupling of the plurality of busbars to the CCU carrier includes retaining the busbar by the second clip member.

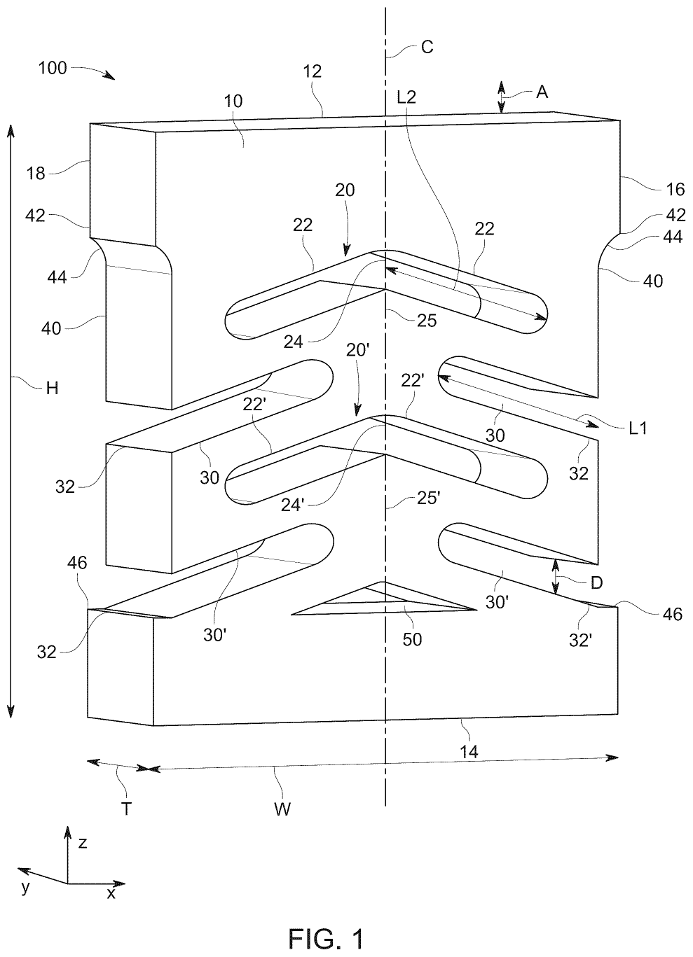

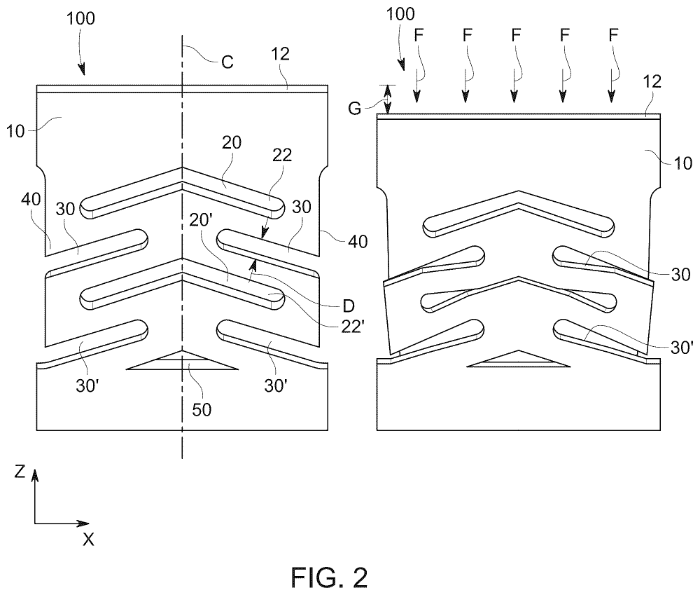

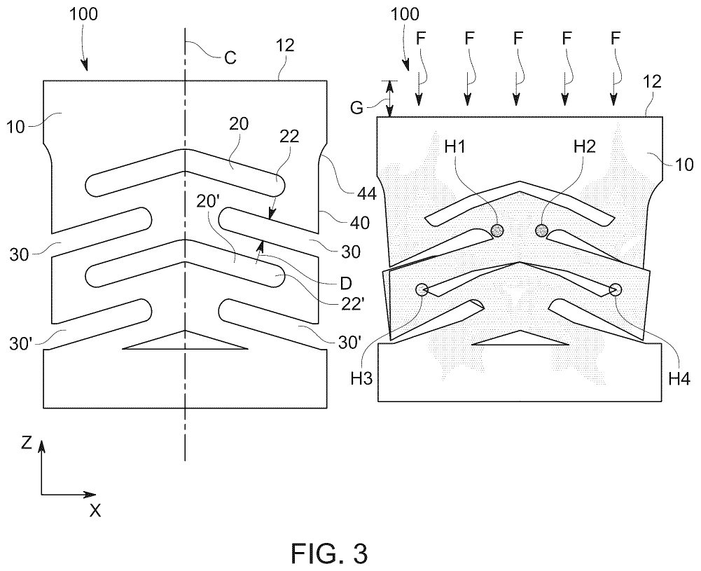

FIG. 1 is a perspective view of a spring 100 according to an embodiment of the present disclosure. The response behavior of the spring 100 to a compressive force F is illustrated in FIGS. 2 and 3. The spring 100 may be used for a cell contact unit (CCU) carrier, as will be described further below.

The spring 100 includes a main body 10. The main body 10 may have a cuboid shape. The main body 10 has a thickness T (e.g., a predefined or predetermined thickness) (in a y-direction). The main body 10 may be flat or thin. For example, a thickness of the main body 10 may be less than a threshold thickness, for example, less than about 1 mm, but the present disclosure is not limited thereto. The main body 10 may have a rectangular or square top surface area (and bottom surface area) defined by a width W (in an x-direction) and the thickness T (in the y-direction). The main body 10 may have a plurality of side portions (e.g., a plurality of sides) 12, 14, 16, 18. The main body 10 has a first spring action side portion 12, or first compression portion, and a second spring action side portion 14, or second compression portion, that is opposite to the first spring action side portion 12. The spring action side portions 12, 14 define a spring action direction A in which the spring 100 can be compressed by a compression force F while providing a restoring force in the direction opposite to the compressing force F. A compression force F acting on the first spring action side portion 12 and the mechanical response of the spring 100 is illustrated in, for example, FIG. 2 or FIG. 3, in which the non-compressed state is shown on the left side and for example the compressed state is shown on the right side.

The main body 10 has at least one V-shaped opening 20, 20′. In the embodiment illustrated in FIG. 1, two V-shaped openings 20, 20′ are provided. In other embodiments, only one V-shaped opening is provided or more than two V-shaped openings are provided depending on the anticipated or desired application. The V-shaped opening 20, 20′ has a plurality of leg openings 22, 22′ penetrating (or extending through) the main body 10 in the thickness direction of the main body 10. In the embodiment illustrated in FIG. 1, two leg openings 22, 22′ are provided in each of the two V-shaped openings 20, 20. The leg openings 22, 22′ together form the V-shape, and the leg openings 22, 22′ meet at a tip point (e.g., a vertex) 24, 24′ of the V-shaped opening 20, 20′. The V-shaped opening 20, 20′ is oriented so that the leg openings 22, 22′ are symmetric with respect to a central axis C of the main body 10. The central axis C is parallel to the spring action direction A. The tip point (vertex) 24, 24′ is directed or points in (or toward) the compression direction F as shown in FIG. 2 or 3. In other embodiment, the tip point (vertex) may point in the opposite direction of the compression direction F.

The main body 10 has at least one pair of slot openings 30, 30′, which penetrates the main body 10 in the thickness direction. The slot openings 30, 30′ respectively extend from opposite transversal side portions 16, 18 of the main body 10 toward the central axis C. Further, the slot openings 30, 30′ respectively extend from opposite transversal side portions 16, 18 of the main body 10 toward the central axis C forming a core portion 25, 25′ therebetween at the center axis (e.g., between where the slot openings 30, 30′ are spaced apart from each other).

The spring 100 has excellent flexibility in the spring action direction A, allowing for a well-defined compression depth G while maintaining stiffness in the transversal direction x perpendicular to the spring action direction A. The stiffness is achieved due to the V-shaped opening(s) 20, 20′ and the slot openings 30, 30′ providing flexibility in response to the applied compression force F. In addition, the main body 10 may include (e.g., may be made of) plastic. For example, the main body 10 may be injection-molded. This may increase ease of manufacturing.

Referring to FIG. 2, the compression depth G is indicated in response to the application of a compression force F on the spring 100, in the illustrated embodiment, to the first spring action side portion 12. As illustrated therein, the two slot openings 30, 30′ reduce their respective diameters D when the main body 10 is compressed. For example, depending on the compression force F, the diameter D may reduce to zero, that is, the inner surfaces of the main body 10 at where the slot openings 30, 30′ are formed contact each other. The maximum compression depth may, thus, be proportional to the diameter D (e.g., to the sum of the diameters D) of the slot openings 30, 30′. Thus, the dimensions of the slot openings 30, 30′ may be used to vary the flexibility according to various specifications.

Referring to FIG. 3, force distribution in the spring 100 is illustrated, by using a Catia (e.g., a computer aided design) simulation, when the spring 100, for example, the first spring action side portion 12, experiences a compression force F. As can be seen in FIG. 3, only very localized hot spots H1, . . . H4 (the brighter shading) referring to inner tensions occur instead of non-localized (e.g., extended) high force regions. Thus, FIG. 3 demonstrates that the forces are uniformly distributed across the spring 100 according to the embodiments of the present disclosure.

The slot openings 30, 30′ may respectively extend in a direction parallel to the leg openings 22, 22′ of the V-shaped opening 20, 20′. This provides a more symmetric distribution of thickness in the structure and helps to uniformly distribute the forces in response to the compression force F applied to the spring 100 as can be seen in FIG. 3.

In addition, the slot openings 30, 30′ respectively extend to overlap with the respective leg openings 22, 22′ when viewed in the spring action direction A as shown in FIG. 1. Thus, because the slot openings 30, 30′ overlap with the leg openings 22, 22′, flexibility may be increased so that a desired compression depth D can be reached.

To ensure sufficient flexibility, a length L1 of the slot openings 30, 30′ may be at least a quarter of the overall width W between the opposite transversal side portions 16, 18 of the main body 10. The length L1 may be varied. Further, a length L2 of the leg openings 22, 22′ may be at least a quarter of an overall width W between the opposite transversal side portions 16, 18 of the main body 10.

The main body 10 has a recessed portion 40 on each of the transversal side portions 16, 18. The recessed portions 40 extend in the spring action direction A on each transversal side portion 16, 18. The slot openings 30, 30′ respectively extend toward the central axis C from a slot start portion 32, 32′ located within the respective recessed portions 40. Thus, the recessed portions 40 support the compression and promotes slight inwardly bending as shown in the compressed states in FIGS. 2 and 3, providing flexibility to the spring 100 and the deformation of the spring 100.

As can be seen in FIG. 1, an end portion 42 (e.g., first end portion) at the side of the transversal side portions 16, 18 of each recessed portion 40 has a curved portion (e.g., a curved surface) 44. This curved portion 44 may facilitate the deformation as shown in FIGS. 2 and 3 when a compression force F acts on the spring 100.

Another end portion 46 (e.g., second end portion) of the recessed portion 40 is at where the slot start portion 32, 32′ is located. A step (e.g., a flat portion or a portion flat with respect to the width direction) is formed when viewed along the transversal side portions 16, 18.

In the embodiment shown in FIG. 1, the main body 10 has a plurality of V-shaped openings 20, 20′ and a plurality of pairs of slot openings 30, 30′, which alternately arranged in the spring action direction A. In the illustrated embodiment, two V-shaped openings 20, 20′ and two pairs of slot openings 30, 30′ are provided. Therefore, while stiffness is maintained in transversal direction, a larger compression depth G may be achieved.

The spring 100 has a triangular opening 50 located at (or along) the central axis C and oriented symmetrically with respect to the central axis C. The triangular opening 50 may point in the same direction as the V-shaped opening 20, 20′. The triangular opening 50 may help provide a homogeneous force distribution over the spring 100 when a load is applied thereto.

In summary, according to various embodiments, some of which are described above, a flat spring 100 may be provided having excellent flexibility in a spring direction while maintaining stiff in a transversal direction.

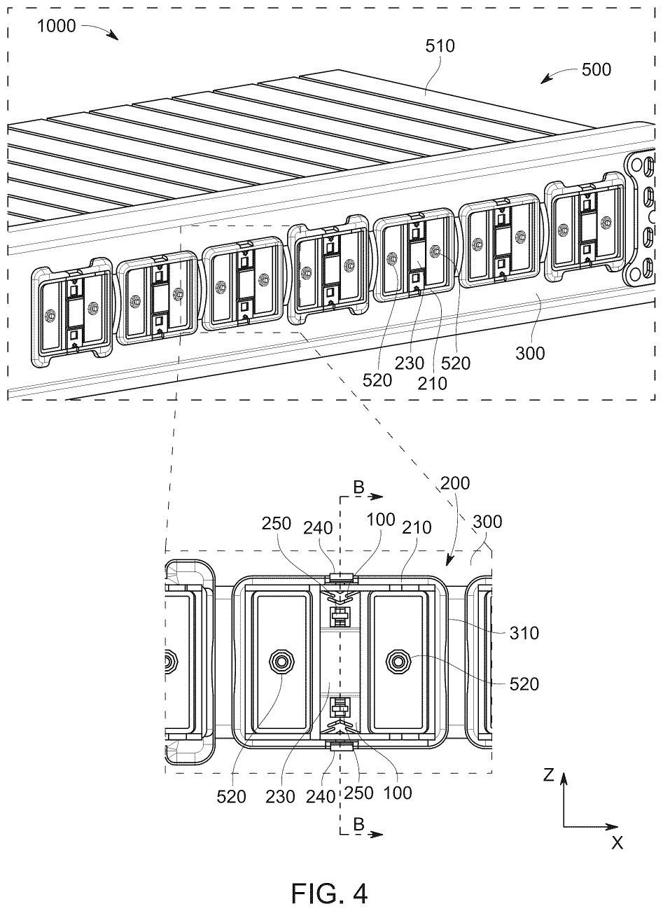

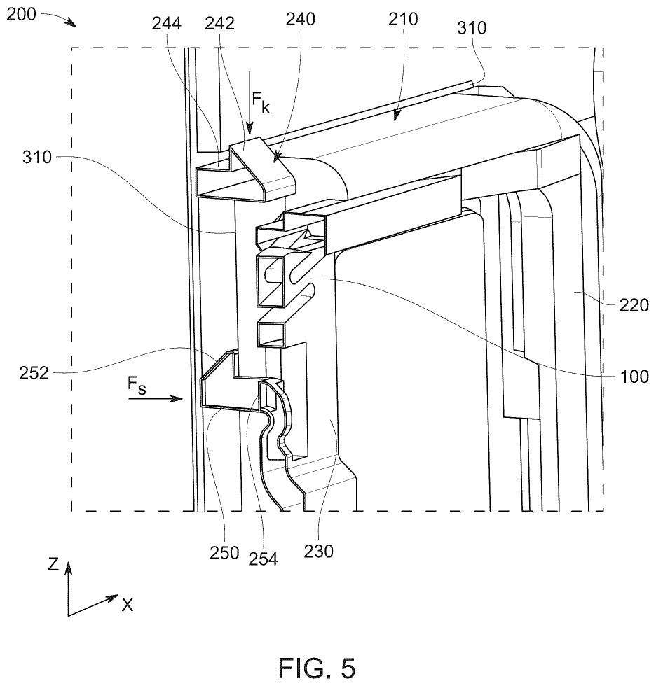

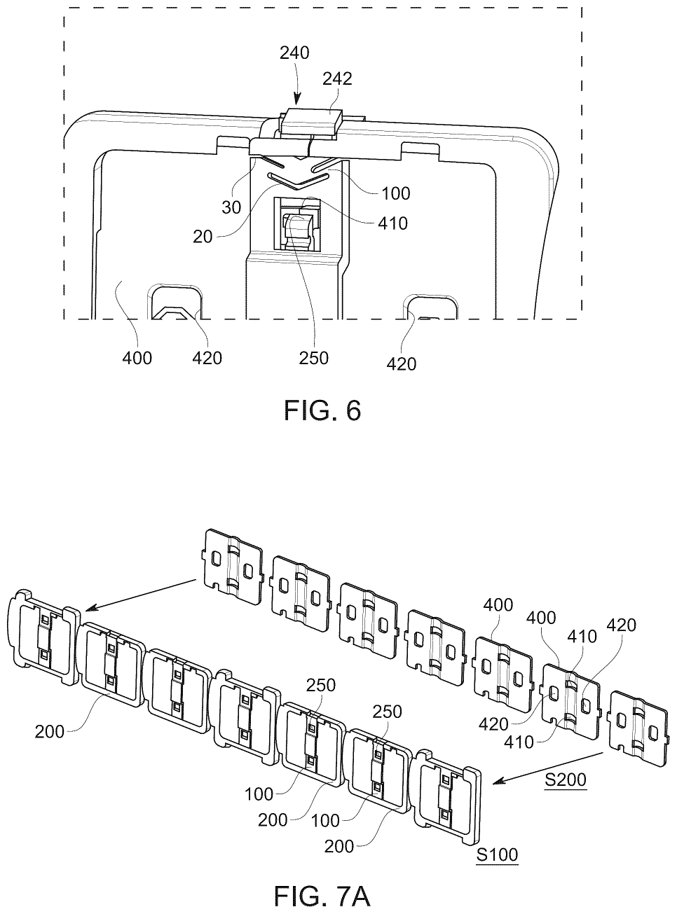

FIG. 4 illustrates a CCU carrier 200 and a battery system 1000 including the CCU carrier 200 according to an embodiment of the present disclosure. FIG. 5 is a cross-sectional view of the CCU carrier 200 taken along the line B in FIG. 4, and FIG. 6 further illustrates a busbar 400.

The CCU carrier 200 includes a carrier member 210, which includes at least one spring 100. The spring 100 may be one of the embodiments thereof as described above. In the illustrated embodiment, two springs 100 are included.

The carrier member 210 may include a carrier frame portion 220, which forms a surrounding structure defining at least one opening. Furthermore, the carrier member 210 includes a carrier bridge portion 230. The carrier bridge portion 230 connects opposite portions (e.g., an upper portion and a lower portion) of the carrier frame portion 220, which divides the opening into a first opening and a second opening. Thus, the carrier member 210 may have two openings separated by the carrier bridge portion 230.

In the illustrated embodiment, the carrier bridge portion 230 may include at least one spring 100. In the illustrated embodiment, two springs 100 are included as example. For example, the spring 100 is embedded in the carrier bridge portion 230 of the carrier member 210. In the illustrated embodiment, the two springs 100 are integral with the carrier bridge portion 230 to form the carrier member 210. Thus, due to the flat geometry of the spring 100, a space efficient inclusion of the spring 100 can be provided.

The carrier member 210 further includes a first clip member 240. In the illustrated embodiment, two first clip members 240 are provided on opposite ends of the carrier member 210. The first clip member 240 is located in mechanical communication with (e.g., in mechanical connection with) the spring 100 so that the spring 100 causes or supports the first clip member 240 to yield during a clipping process. Thus, the spring 100 may facilitate or support the first clip member 240 in yielding, that is, from moving in the spring action direction A, during the clipping process.

For example, as shown in FIGS. 4 and 5, the first clip members 240 are clipped into or with a frame opening 310 of a frame support member 300. For example, the CCU carrier 200 is clipped into the frame support member 300 from an inside at the point where the force Fₖ acts, as shown in FIG. 5. Due to the excellent flexibility of the spring 100 in the spring action direction A, as described above, an improved clipping mechanism is provided. The spring 100 having the V-shaped openings 20, 20′ and the slot openings 30, 30′ ensures flexibility at the location of the first clip member 240. The first clip members 240 may include a first retention protrusion 242. The first retention protrusion 242 interacts with the boundary of (e.g., the material surrounding) the frame opening 310 and may yield in support by the spring 100. The spring 100 is connected through a first connection member 244. The first retention protrusion 242 may, after the clipping is completed, arrest the carrier member 210 in (or against) the frame support member 300 once pushed through the frame opening 310, as shown in, for example, FIG. 5.

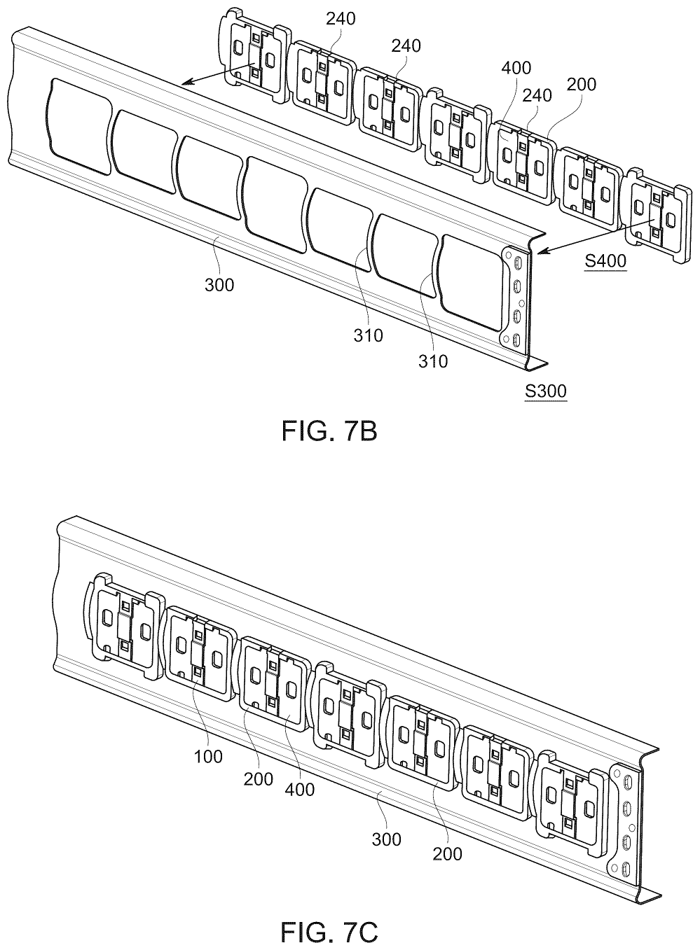

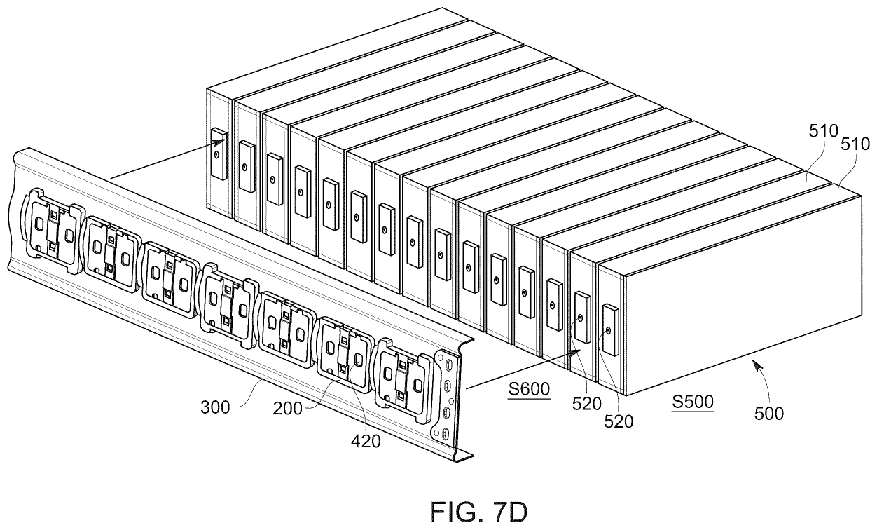

Further, the carrier member 210 may include a second clip member 250. The second clip member 250, as shown in FIG. 5, may extend in a transversal direction (opposite of the force Fₖ as indicated in FIG. 5) with respect to the spring action direction A. The second clip member 250 may retain or fixate a busbar 400 (see, e.g., FIGS. 6 and 7A) that is coupled to the carrier member 210. The busbar 400 may have a fixation opening 410 for coupling with the second clip member 250. Because the spring 100, according to embodiments as described above, is relatively stiff in a transversal direction where the busbar 400 is held or fixated by the second clip member 250 (at the indicated point Fₛ in FIG. 5), even in an event of clipping and, thus, compression of the spring 100 (see indication by Fₖ as shown in FIG. 5), the spring 100 may remain stiff to retain or fixate the busbar 400 to be stably held in place. The second clip member 250 may have a second retention protrusion 252. The second retention protrusion 252 may interact with the busbar 400 (see, e.g., FIG. 6) and may hold the busbar 400 in the carrier member 210 (see, e.g., FIGS. 7A and 7B). The connection member 254, for example, bars, may connect the second clip member 250 to the carrier bridge portion 230 or carrier member 210.

As can be seen in FIG. 4, the battery system 1000 includes a plurality of CCU carriers 200 in accordance with embodiments of the present disclosure. In addition, the battery system 1000 includes a plurality of battery cells 510 forming a battery cell stack 500. The battery cell stack 500 may be framed by the at least one frame support member 300 having the plurality of frame openings 310, as described above.

The battery system 1000 includes the plurality of CCU carriers 200 clipped into respective frame openings 310 of the frame support member 300 by a first clip member 240 that is in mechanical communication with the spring 100. The mechanical communication is such that the first clip member 240 may yield, or at least support yielding, through the spring action of the spring 100 when the carrier member 210 is clipped into a respective frame opening 310, as described above.

The battery cells 510, or the battery cell stack 500, further include side terminals 520 at a side of the battery cell stack 500. These side terminals 520 are located in the openings formed by the carrier frame portion 220 in the coupled state of the frame support member 300 coupled with the battery cell stack 500. The busbars 400 may have terminal openings 420 (see, e.g., FIG. 7A) corresponding to the side terminals 520.

FIGS. 7A to 7D illustrate steps of a method of manufacturing of the battery system 1000 according to an embodiment of the present disclosure.

As shown in FIG. 7A, the method includes a step S100 of providing a plurality of CCU carriers 200. The CCU carriers 200, according to embodiments, are described above and such description is incorporated herein by reference. The CCU carriers 200 may be connected with each other or may be integrally formed.

According to an embodiment and as shown in FIG. 7A, a plurality of busbars 400 is coupled S200 to a respective CCU carrier 200. The coupling may, for example, include a step of welding to ensure a stable contact. In addition, the carrier member 210 of the CCU carrier 200 may further include a second clip member 250, as described above, which extends in a transversal direction with respect to the spring action direction A. The coupling S200 of the plurality of busbars 400 to the CCU carrier 200 may, thus, include fixing the busbars 400 to carrier member 210 by the second clip member 250. The busbars 400 may have fixation openings 410 for coupling the busbars within the carrier member 210. The busbars 400 may further include terminal openings 420 (see, e.g., FIG. 7A) corresponding to the side terminals 520.

According to an embodiment and as shown in FIG. 7B, the method includes a step S300 of providing at least one frame support member 300 having a plurality of frame openings 310. The frame support member 300 may be a metal frame, for example, a punched metal frame. The frame support member 300 has a plurality of frame openings 310.

According to an embodiment and as shown in FIG. 7B, the method includes clipping S400 the plurality of CCU carriers 200, having the busbars 400 coupled thereto, into the respective frame openings 310 so that the first clip member 240 yields through, or through support of, the spring action of the spring 100 during the clipping of the CCU carrier 200 into the respective frame opening 310 until it is arrested in the frame opening 310 of the frame support member 300. The result of this clipping action is shown in FIG. 7C. Due to the thin spring 100 having excellent flexibility in the spring action direction A, the coupling process is easily facilitated. In addition, because the spring 100 maintains stiffness in the transversal direction perpendicular to the spring action direction A, the busbars 400 coupled prior thereto are held in place. The stiffness of the spring 100 is achieved due to the V-shaped opening 20, 20′ and the slot openings 30, 30′ while allowing for flexibility in response to compression as in the clipping case according to step S400.

According to an embodiment and as shown in FIG. 7D, the method includes the step S500 of providing a battery cell stack 500 including a plurality of battery cells 510. The battery cells may include side terminals 520.

According to an embodiment and as shown in FIG. 7D, the method includes the step S600 of coupling the frame support member 300 including the clipped plurality of CCU carriers 200 to a respective side of the battery cell stack 500. For example, the frame support member 300 may be coupled to sides of the battery cell stack 500 by using an adhesive, mechanical coupling, and/or welding. Thus, a battery system 1000, as described above, may be obtained.

In summary, a spring 100 is provided having excellent flexibility in a spring action direction allowing for a well-defined spring compression length while maintaining stiffness in the transversal direction perpendicular to the spring action direction due to its various structural features as described above. As a result, the spring 100 has excellent damping properties with homogeneous force distribution in the direction of the line of action of the force. Further, the spring 100 requires little space and can be held very flat and, thus, can be integrated in space saving manner, for example, by being integrated in a CCU carrier 200. The spring 100 can be manufactured in an easy (injection) moulding process.

### SOME REFERENCE SYMBOLS

100 spring
10 (flat) main body
12 first spring action side portion
14 second spring action side portion
16 first side portion
18 second side portion
20, 20′ V-shaped opening
22, 22′ leg opening
24, 24′ tip point (vertex)
25, 25′ core portion
30, 30′ slot opening (pair)
32, 32′ slot start portion
40 recessed portion
42 first end portion
44 curved portion
46 second end portion
50 triangular opening
200 CCU carrier
210 carrier member
220 carrier frame portion
230 carrier bridge portion
240 first clip member
242 first retention protrusion
244 first connection member
250 second clip member
252 second retention protrusion
254 second connection member
300 frame support member
310 frame opening
400 busbar
410 fixation opening
420 terminal opening
500 battery cell stack
510 battery cell
520 side terminal
1000 battery system
L1 length of slot opening
L2 length of leg opening
D diameter of slot opening
T thickness
W (overall) width
H height
A spring action direction
F compression force
G compression depth
S100 providing a plurality of CCU carriers
S200 coupling a plurality of busbars to the CCU carrier
S300 providing at least one frame support member including a plurality of frame openings
S400 clipping the plurality of CCU carriers with the coupled busbars into respective frame openings
S500 providing a battery cell stack including a plurality of battery cells
S600 coupling the least one frame member to at least one respective side of the battery cell stack

What is claimed is:

1. A spring for a battery system, the spring comprising:
a main body having a first spring action side, a second spring action side opposite to the first spring action side in a spring action direction, a first side, and a second side opposite to the first side,
wherein the main body has a V-shaped opening comprising a plurality of leg openings extending through the main body in a thickness direction of the main body and a pair of slot openings extending through the main body in the thickness direction,
wherein the V-shaped opening is oriented such that the plurality of leg openings are symmetric with respect to a central axis of the main body, which is parallel to the spring action direction, and
wherein the pair of slot openings respectively extend from the first side and the second side of the main body toward the central axis.

2. The spring as claimed in claim 1, wherein the pair of slot openings respectively extend in a direction parallel to respective ones of the plurality of leg openings of the V-shaped opening.

3. The spring as claimed in claim 2, wherein the pair of slot openings respectively extend to overlap with the respective ones of the plurality of leg openings in the spring action direction.

4. The spring as claimed in claim 1, wherein a length of at least one of the slot openings and/or of at least one of the leg openings is at least a quarter of an overall width of the main body between the first and second sides.

5. The spring as claimed in claim 1, wherein the main body has a recessed portion on each of the first and second sides and extending in the spring action direction, and
wherein the pair of slot openings respectively extend toward the central axis from a slot start portion open to corresponding one of the recessed portions.

6. The spring as claimed in claim 5, wherein an end portion of the recessed portions has a curved portion.

7. The spring as claimed in claim 6, wherein another end portion of the recessed portions is at the corresponding slot start portion.

8. The spring as claimed in claim 1, wherein the main body has a plurality of the V-shaped openings and a plurality of the pairs of slot openings, which are alternatingly arranged in the spring action direction.

9. The spring as claimed in claim 1, wherein the main body comprises plastic or metal.

10. A cell contact unit (CCU) carrier for a battery system, the CCU carrier comprising:
a carrier member comprising:
the spring as claimed in claim 1; and
a first clip member in mechanical communication with the spring such that the first clip member yields in the spring action direction in response to compression thereof during clipping.

11. The CCU carrier as claimed in claim 10, wherein the carrier member further comprises a second clip member extending in a transversal direction with respect to the spring action direction and configured to retain a busbar that is coupled to the carrier member.

12. A battery system comprising:
a battery cell stack comprising a plurality of battery cells;
a frame support member coupled to the battery cell stack and having a plurality of frame openings; and
a plurality of CCU carriers, each comprising a carrier member comprising a first clip member in mechanical communication with the spring as claimed in claim 1,
wherein the plurality of CCU carriers are clipped into respective one of the frame openings of the frame support member by the corresponding first clip member such that the first clip member yields in the spring action direction in response to compression of the spring during clipping.

13. The battery system as claimed in claim 12, wherein the carrier member further comprises a second clip member extending in a transversal direction with respect to the spring action direction and is configured to retain a busbar that is coupled to the carrier member.

14. A method of manufacturing a battery system, the method comprising:
coupling a plurality of busbars to respective ones of the CCU carriers as claimed in claim 10;
clipping the plurality of CCU carriers with the coupled busbars into respective frame openings in a frame support member such that the first clip member yields through spring action of the spring during the clipping of the CCU carrier into the respective frame opening until being retained in the frame opening of the frame support member; and
coupling the frame support member comprising the clipped plurality of CCU carriers to a side of a battery cell stack.

15. The method as claimed in claim 14, wherein the carrier member further comprises a second clip member extending in a transversal direction with respect to the spring action direction, and
wherein the coupling of the plurality of busbars to the CCU carrier comprises holding the busbar by the second clip member.
